(19) United States
(12) Patent Application Publication
(10) Pub. No.: US 2002/0081101 A1
(43) Pub. Date: Jun. 27, 2002

(54) Write-once disc recording system with audio after-recording capability

(76) Inventors: Kazuhiko Taira, Yokohama-shi (JP); Hideki Mimura, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/003,280

(22) Filed: Dec. 6, 2001

(30) Foreign Application Priority Data
Dec. 27, 2000 (JP) 2000-399293

(51) Int. Cl. H04N 7/04; H04N 7/06; H04N 7/08; H04N 5/781

(52) U.S. Cl. 386/96; 386/98; 386/125

(57) ABSTRACT

In a system, primary audio stream A0 and secondary audio stream A1 are recorded on a write-once type recording medium such as a DVD-R. The system comprises first to third recording sections. The first recording section is configured to record a first original audio stream as stream A0 on the DVD-R. The second recording section is configured to record a second original audio stream as stream A1 on the DVD-R. The second original audio stream is recordable independently of the first original audio stream. The third recording section is configured to record a modified audio stream as stream A1 on the DVD-R. The modified audio stream is obtained by partially or entirely modifying the second original audio stream.

### CROSS-REFERENCE TO RELATED APPLICATIONS

This application is based upon and claims the benefit of priority from the prior Japanese Patent Application No. 2000-399293, filed Dec. 27, 2000, the entire contents of which are incorporated herein by reference.

### BACKGROUND OF THE INVENTION

1. Field of the Invention

The present invention relates to an optical disc recording/reproduction system for editing audio information after recording on a write-once, read-many optical disc on/from which video information and/or audio information can be recorded and reproduced.

2. Description of the Related Art

In recent years, DVD (Digital Versatile Disc) has been developed and produced in various forms, and such products have prevailed. Further, the market requires higher-performance products across various fields. To meet such requirements, the DVD forum has specified a DVD-RAM disc that allows recording/reproduction, i.e., “DVD Specifications for Rewritable Disc, Part 1: PHYSICAL SPECIFICATIONS, Part 2: FILE SYSTEM SPECIFICATIONS”, or a DVD-RW (Re-recordable) disc, i.e., “DVD Specifications for Re-recordable Disc, Part 1: PHYSICAL SPECIFICATIONS, Part 2: FILE SYSTEM SPECIFICATIONS” in 1999. Moreover, DVD video recording (DVD video recording) specifications as application specifications that exploit these rewritable discs, i.e., “DVD Specifications for Rewritable/Re-recordable Discs Part 3: VIDEO RECORDING” have been issued in September 1999, and products which use the specifications have been put on the market at the end of 1999.

In September 2000, a DVD-R for general disc “DVD Specifications for Recordable Disc for General, Part 1: PHYSICAL SPECIFICATIONS, Part 2: FILE SYSTEM SPECIFICATIONS” as a write-once, read-many disc, which can be applied to the DVD video recording application specifications, was added in addition to the aforementioned rewritable discs.

Originally, the requirement specifications and function specifications of the DVD video recording application specifications were determined and specified on the basis of the aforementioned rewritable disc. Upon application to a write-once, read-many disc, since its recording method is different from that of the rewritable disc, some new devises are required to implement all functions specified by the video recording application specifications.

As a disclosed technique that pertains to an audio after-recording function, Jpn. Pat. Appln. KOKAI Publication No. 11-298,845 is known. This reference has exemplified an after-recording process for a rewritable DVD-RAM (Random Access Memory). However, this reference is not directed to a write-once, read-many disc, and discloses an audio-only after-recording process.

The audio after-recording function requires a sequence for reading out an audio stream of an audio after-recording area, executing after-recording edit of the readout audio stream, and then writing back the edited stream. Therefore, in a write-once, read-many disc such as a DVD-R or the like in which data once written in a given area cannot be rewritten, such audio after-recording function cannot be implemented.

### BRIEF SUMMARY OF THE INVENTION

According to an aspect of the present invention, a new audio stream created as a result of an after-recording process is additionally recorded in a new storage area in place of being overwritten on the recorded stream, thus allowing to repeat the after-recording process even in a write-once disc such as a DVD-R.

### BRIEF DESCRIPTION OF THE SEVERAL VIEWS OF THE DRAWING

FIG. 1 is a block diagram showing an embodiment of an optical disc recording/reproduction system (apparatus) with an audio after-recording function according to the present invention;

FIG. 2 is an explanatory view for explaining an embodiment of the audio after-recording function of the optical disc recording/reproduction system with an audio after-recording function according to the present invention;

FIG. 3 is an explanatory view for explaining another embodiment of the audio after-recording function of the optical disc recording/reproduction system with an audio after-recording function according to the present invention;

FIG. 4 is a flow chart showing the recording operation of the optical disc recording/reproduction system with an audio after-recording function according to the present invention; and

FIG. 5 is a flow chart showing the reproduction operation of the optical disc recording/reproduction system with an audio after-recording function according to the present invention.

### DETAILED DESCRIPTION OF THE INVENTION

An embodiment of an optical disc recording/reproduction system (apparatus) with an audio after-recording function will be described in detail hereinafter with reference to the accompanying drawings.

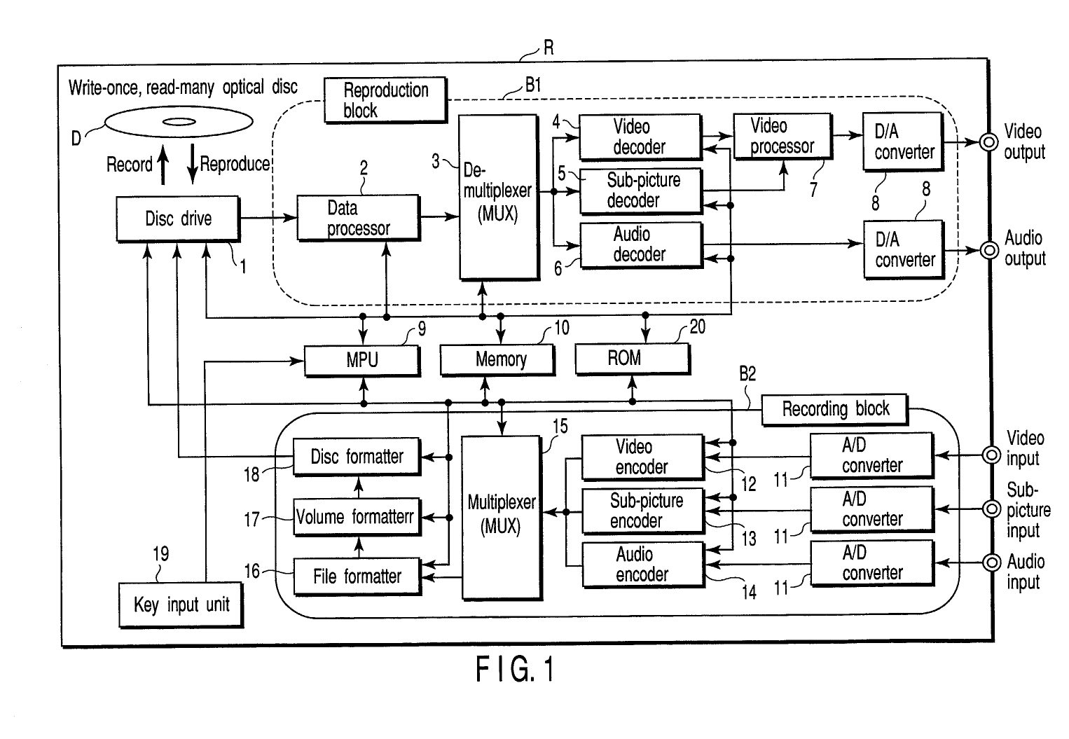

FIG. 1 is a block diagram showing an optical disc recording/reproduction system with an audio after-recording function according to an embodiment of the present invention.

<Example of Arrangement of Optical Disc Recording/Reproduction Apparatus>

Optical disc recording/reproduction apparatus R comprises disc drive 1 for write-once, read-many optical disc (e.g., DVD-R disc) D. The apparatus R also comprises key input unit 19 for respective operations, reproduction block B1 for a reproduction process of an optical disc, recording block B2 for a recording process, MPU 9 for controlling the optical disc recording/reproduction apparatus, memory 10 mainly used to execute data processes, and ROM 20 for storing at least programs of respective operation processes such as sequences that allow an audio after-recording function according to an embodiment of the present invention.

Reproduction block B1 has data processor 2 for performing signal demodulation and error correction of data output from disc drive 1, and demultiplexer (DMUX) 3 for demultiplexing a data sequence in a pack format, which forms a time-division multiplexed MPEG2 program stream output from data processor 2, into four types of packs, i.e., video packs consisting of video data, sub-picture packs consisting of sub-picture data, audio packs consisting of audio data, and control packs consisting of control data, and transferring respective data to corresponding decoders, i.e., a video decoder 4, sub-picture decoder 5, and audio decoder 6, and control data to memory 10, which can be referred to by MPU 3, with reference to ID data which are recorded in respective data and indicate their transfer times and data types.

Video decoder 4 decodes video data transferred from demultiplexer 3, and transfers decoded data to video processor 7. Sub-picture decoder 5 decodes sub-picture data transferred from demultiplexer 3, and transfers decoded data to video processor 7. Audio decoder 6 decodes audio data transferred from demultiplexer 3, and transfers decoded data to D/A converter 8. Video processor 7 mixes data output from video decoder 4 and sub-picture decoder 5. D/A converter 8 converts a digital signal output from audio decoder 6 into an analog signal. The signal converted by D/A converter 8 is reproduced by a TV monitor, loudspeaker, and the like (not shown) via video and audio output terminals.

Memory 10 temporarily saves data, and key input unit 19 is provided to receive user's instructions and requests.

In the recording block shown in FIG. 1, A/D converters 11 convert data input via video, audio, and sub-picture input terminals from analog signals into digital signals. Video encoder 12 encodes digital video data converted by A/D converter 11. Sub-picture encoder 13 encodes digital sub-picture data converted by A/D converter 11. Audio encoder 14 encodes digital audio data converted by A/D converter 11. Multiplexer (MUX) 15 packetizes and packs video, audio, and sub-picture data encoded by the respective encoders into video, audio, and sub-picture packs to form an MPEG2 program stream.

File formatter 16 converts a multiplexed data group into a file complying with a file structure which can be recorded/reproduced by the optical disc recording/reproduction apparatus R. Volume formatter 17 forms a data format complying with a volume structure which can be recorded/reproduced by the optical disc recording/reproduction apparatus R. Volume formatter 17 appends data which has been converted into a file by file formatter 16, reproduction control information used to reproduce that data which has been converted into a file, and the like. Physical formatter 18 is provided to record data on optical disc D. File formatter 16 and volume formatter 17 are logical formatters, and physical formatter 18 is a disc formatter for recording data which has been formatted by these formatters on optical disc D via disc drive 1.

ROM 20 stores a series of processing programs of the optical disc recording/reproduction apparatus R, and the apparatus operates when these programs are executed by MPU 9.

According to a DVD specification for Rewritable/Re-recordable discs (or DVD video recording specifications), a primary audio stream and a secondary audio stream are available. The primary audio stream whose stream number is ‘0’ has two states (original state and modified state) and the secondary audio stream whose stream number ‘1’ has four states (original state, modified state, dummy state, and after-recorded state).

Further, a management information (RTR_VMG/M_AVFIT/M_AVFI/M_VOBI/M_VOB_GI) defined in the DVD specification for Rewritable/Re-recordable discs includes type information (VOB_TY) of a data object (VOB). (The VOB may be formed of video object data relating to video streams and of audio object data relating to audio streams.) The type information includes two status information items (A0_STATUS and A1_STATUS).

When A0_STATUS=00b, audio stream#0 (stream A0) is recorded as an original audio stream when the VOB was created, and it has not been modified. The player (reproduction block B1 in FIG. 1) shall allow a user to select this audio stream to be presented.

When A0_STATUS=01b, audio stream#0 (stream A0) is recorded as an original audio stream when the VOB was created, and it has been modified partially or entirely. The player (reproduction block B1) shall allow a user to select this audio stream to be presented.

Incidentally, the state of each of A0_STATUS=10b and A0_STATUS=11b is reserved.

When A1_STATUS=00b, audio stream#1 (stream A1) is recorded as an original audio stream when the VOB was created, and it has not been modified. The player (reproduction block B1) shall allow a user to select this audio stream to be presented.

When A1_STATUS=01b, audio stream#1 (stream A1) is recorded as an original audio stream when the VOB was created, and it has modified partially or entirely. The player (reproduction block B1) shall allow a user to select this audio stream to be presented.

When A1_STATUS=10b, audio stream#1 (stream A1) is recorded as a dummy audio stream for audio dubbing purpose when the VOB was created, and it has not been modified yet (or, audio dubbing has not been done yet). This audio stream shall be the same as the primary audio stream (A0) except for a stream number at the packet layer. The player (reproduction block B1) shall not allow a user to select this audio stream to be presented.

When A1_STATUS=11b, audio stream#1 (stream A1) is recorded as a dummy audio stream for audio dubbing purpose when the VOB was created, and has already been modified partially or entirely (or, audio dubbing has already been done). The player (reproduction block B1) shall allow a user to select this audio stream to be presented.

Incidentally, when A1_STATUS=‘10b’ or ‘11b’, then A0_STATUS=01b shall not be described. When audio stream#0 and audio stream#1 have the same contents, audio stream#1 shall be modified in stead of audio stream#0.

In the following, description will be given to the state of audio stream and the mechanism to dub after-recorded audio stream without any modification of the original audio stream.

The primary audio stream whose stream number is ‘0’ has two states and the secondary audio stream whose stream number is ‘1’ has four states as follows:

<Primary Audio Stream>

Original State (A0_STATUS=00b)

This state indicates that the primary audio stream is an original audio stream which was recorded at the same time when the VOB, which indicates this primary audio stream, was created.

Modified State (A0_STATUS=01b)

This state indicates that the primary audio stream has been modified partially or entirely after the VOB, which indicates this audio stream, was created.

<Secondary Audio Stream>

Original State (A1_STATUS=00b)

This state indicates that the secondary audio stream is an original audio stream which was recorded at the same time when the VOB, which indicates this audio stream, was created.

Modified State (A1_STATUS=01b)

This state indicates that the secondary audio stream has been modified partially or entirely after the VOB, which indicates this audio stream, was created.

Dummy State (A1_STATUS=10b)

This state indicates that the secondary audio stream is a dummy audio stream to be dubbed into after-recorded audio stream for the future.

In this state, the secondary audio stream shall be the same as the primary one except for a stream number at the packet layer.

In other words, the N-th pack in the sequence of the secondary audio stream (A1) shall include the same audio data that the N-th pack in the sequence of the primary audio stream (A0) includes.

The player (reproduction block B1 in FIG. 1) shall not present the secondary audio stream in the dummy state.

After-Recorded State (A1_STATUS=11b)

This state indicates that the secondary audio stream has been modified partially or entirely after the VOB, which indicates this audio stream, was created.

The difference from the modified state (A1_STATUS=01b) is that the after-recorded state (A1_STATUS=11b) is able to be transited from only the dummy state (A1_STATUS=10b).

More specifically, when any modification is executed, the state of the secondary audio stream shall be transited from the dummy state to the after-recorded state. When the secondary audio stream is restored to the original audio stream completely using the primary one, the state of the secondary audio stream shall be transited from the after-recorded state to the dummy state.

In the following, description will be given to a manner of multiplexing a dummy audio stream.

The secondary audio stream which is a dummy audio stream to be replaced by an after-recorded audio stream needs to be recorded for reserving a room at VOB recording time, because no room for the after-recorded audio stream is reserved in a general MPEG Program stream.

The secondary audio stream shall be the same as the primary one except for a stream number at the packet layer. When the audio streams are recorded, the A1_STATUS may be set to ‘10b’ that means this audio stream is recorded to be dubbed into an after-recorded audio stream in the future. If the A1_STATUS may be set to ‘10b’, the player (reproduction block B1 in FIG. 1) shall not present the secondary audio stream, because the audio content of this stream is the same as that of the primary one.

In the following, description will be given to a manner of replacing the secondary audio stream by an after-recorded audio stream.

If the recorder (recording block B2 in FIG. 1), which has a capability to dub an after-recorded audio stream, finds the A1_STATUS set to ‘10b’, the recorder may replace the recorded audio stream by the after-recorded audio stream at pack-by-pack manner.

In the following, description will be given to a manner of restoring the after-recorded audio stream to the original audio stream.

If a user wants to restore the after-recorded audio stream to the original audio stream, it is able to be restore using the primary audio stream. Because the dummy audio stream is the same as the primary one except for a stream number at the packet layer, restoring the secondary audio stream may be performed by replacing the modified packets with the original one kept in the primary audio stream. After this operation, the A1_STATUS shall be set to ‘10b’.

<Processing Operation of Optical Disc Recording/Reproduction Apparatus>

The operation principle of the aforementioned optical disc recording/reproduction apparatus R will be described in detail below using the accompanying drawings.

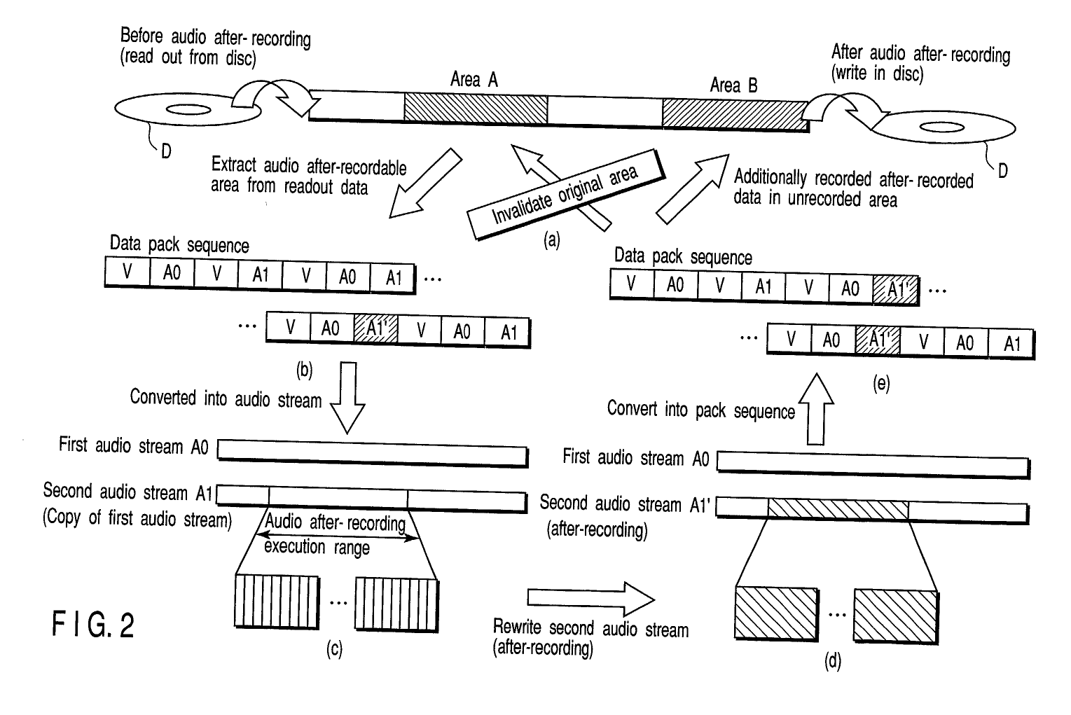

FIG. 2 is an explanatory view showing an embodiment of the present invention which implements an audio after-recording function specified by the DVD video recording application specifications using a DVD-R (write-once, read-many disc) for general.

As shown in (a) of FIG. 2, area A of DVD-R disc D records in advance two audio streams, i.e., first audio stream (primary audio stream) A0, and second audio stream (secondary audio stream) A1 which has the same contents as the first audio stream and is recorded for the purpose of after-recording.

Upon executing audio after-recording in DVD-R disc D, the reproduction block B1 of the optical disc recording/reproduction apparatus R shown in FIG. 1 reads out the contents of area A from DVD-R disc D, and stores them in memory 10.

As shown in (b) of FIG. 2, the acquired data is formed of a data pack sequence including video packs (V), first audio packs (A0), second audio packs (A1), and the like. In memory 10, the audio packs are converted into an audio stream, as shown in (c) of FIG. 2, and second audio stream A1 is partially or entirely replaced by another audio stream A1′ in accordance with an audio after-recording execution range designated by the user via key input unit 16, as shown in (d) of FIG. 2. After that, the audio stream is converted into audio packs, and these audio packs are then converted into an original data pack sequence, as shown in (e) of FIG. 2.

The recording block B2 of the optical disc recording/reproduction apparatus shown in FIG. 1 additionally records the obtained sequence in area B of DVD-R disc D, as shown in (a) of FIG. 2, thus implementing the audio after-recording function.

After completing the above audio after-recording, contents of original area A may be invalidated (or inactive) and contents of newly recorded area B may be validated (or active).

Note that a series of processing sequences mentioned above is attained by executing an audio after-recording processing program stored in ROM 20 by MPU 9.

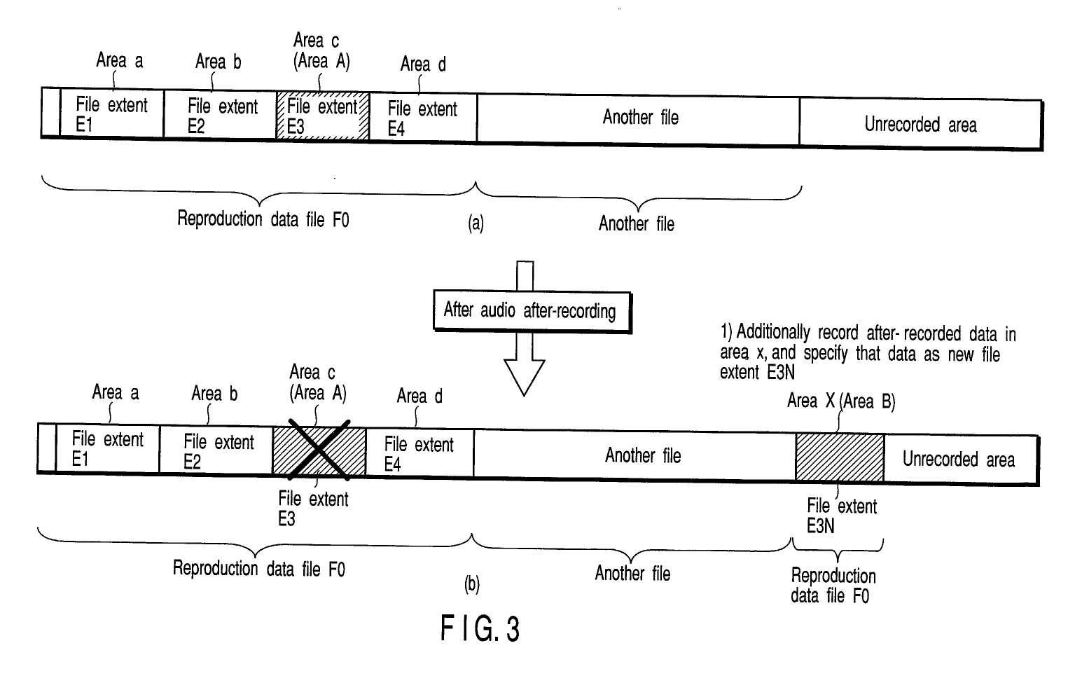

FIG. 3 is an explanatory view for explaining an example that implements the audio after-recording function. This audio after-recording function is attained by changing file management information that manages the entire reproduction data file, since the audio after-recorded area described using FIG. 2 is handled as a file extent. The portion (a) of FIG. 3 shows a data recording area of DVD-R disc D before audio after-recording, and the portion (b) shows a data recording area of DVD-R disc D after audio after-recording.

Reproduction data file F0 before audio after-recording in (a) of FIG. 3 is formed of four file extents E1 to E4 in areas a, b, c, and d. Upon executing the audio after-recording function explained in FIG. 2 for area c of file extent E3 which forms reproduction data file F0, the data obtained after the audio after-recording is additionally recorded in area X. At the same time, area c (file extent E3) is excluded from reproduction data file F0, and area X is defined as file extent E3N of reproduction data file F0, as shown in (b) of FIG. 3, thus implementing the audio after-recording function specified by the DVD video recording specifications.

Therefore, at this time, reproduction data file F0 after audio after-recording is formed of four file extents E1 to E4 in areas a, b, X, and d.

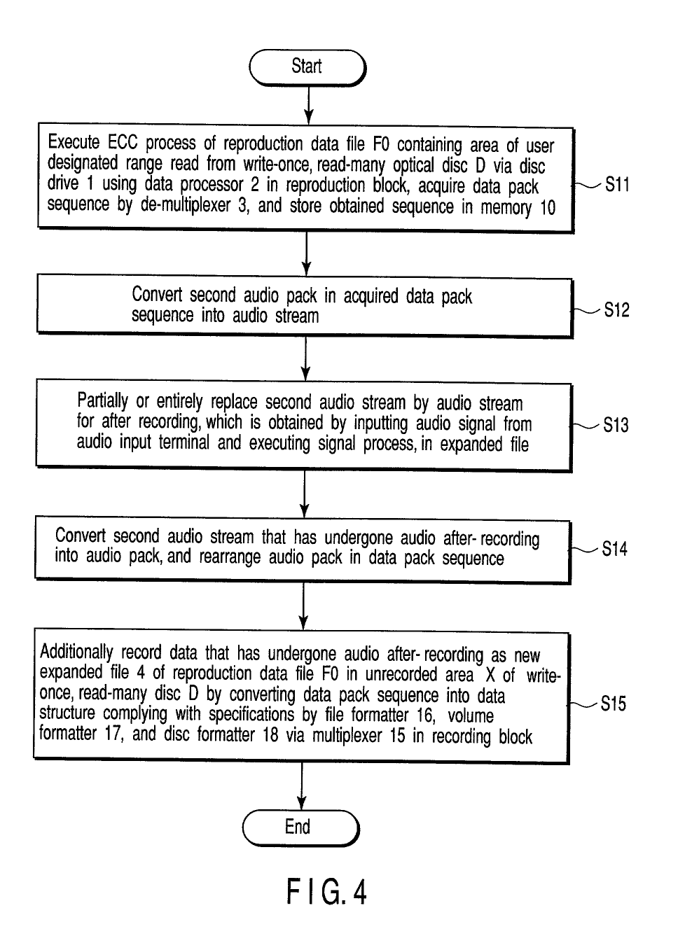

FIG. 4 is a flow chart showing the recording operation of an optical disc recording/reproduction apparatus (R in FIG. 1) with an audio after-recording function according to an embodiment of the present invention. The recording operation will be explained below using this flow chart.

Referring to FIG. 4, when the audio after-recording function starts, a user designates the audio after-recording range. Then, optical disc recording/reproduction apparatus R in FIG. 1 reads file extent E3 from disc D via disc drive 1 using data processor 2 in reproduction block B1, and executes ECC processing of the read file extent E3. The read file extent E3 (having been subjected to the ECC processing) contains an area (c) corresponding to the user designated range in reproduction data file F0. The apparatus R acquires a data pack sequence of the read file extent E3 using demultiplexer 3, and stores that sequence (data packs) in memory 10 (step S11).

From the acquired data pack sequence, the packs of the second audio stream are converted into an audio stream which can be edited for respective audio frames (one audio frame is 1/600 sec in linear PCM at sub-sampling frequency 48 kHz, and quantization bit 16 bits) (step S12).

The second audio stream, i.e., the content of file extent E3 in area c is partially or entirely replaced by an audio stream for after-recording, in units of audio frames, according to the user designated range. This audio stream for after-recording can be obtained by converting an analog audio signal, input from an audio input terminal, into a digital audio signal by A/D converter 11 (step S13).

Furthermore, the second audio stream that has undergone audio after-recording is converted into audio packs, which are re-arranged in the data pack sequence (step S14).

Finally, the data pack sequence is converted via multiplexer 15 to form a data structure complying with the DVD video recording specifications by means of file formatter 16, volume formatter 17, and disc formatter 18 in recording block B2.

Then, data that has undergone audio after-recording is additionally recorded in unrecorded data X of DVD-R disc D as new file extent E3 of reproduction data file F0 (step S15).

With this process, data according to the after-recording process is written in new storage area X and, hence, the writing according to the audio after-recording process can be made on a write-once, read-many disc such as DVD-R wherein data can be written only once for each storage area.

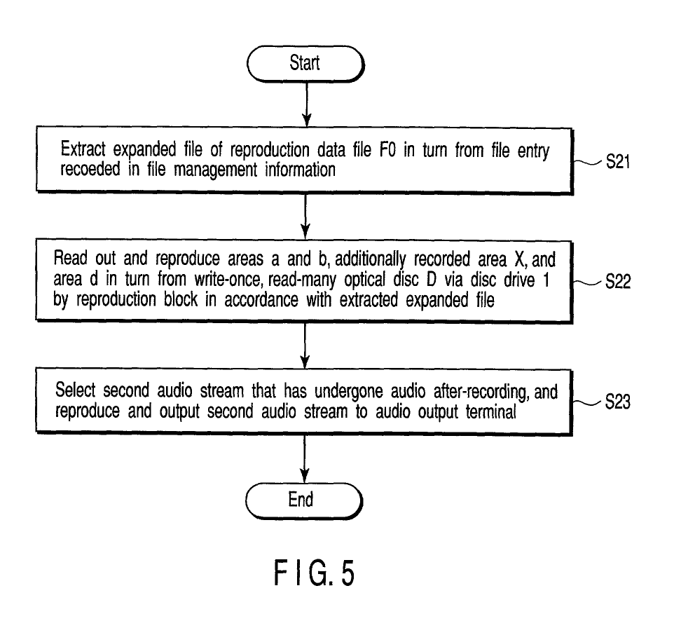

FIG. 5 is a flow chart showing the reproduction operation in the optical disc recording/reproduction apparatus with an audio after-recording function according to an embodiment of the present invention.

Referring to FIG. 5, when reproduction including an area that has undergone audio after-recording starts, the file extents of reproduction data file F0 are extracted in turn from a file entry recorded in file management information (step S21).

The reproduction block B1 reads out and reproduces areas a and b, additionally recorded area X, and area d in turn from DVD-R disc D via disc drive 1 in accordance with the extracted file extents (step S22).

In this case, another audio stream (A1′ in (d) of FIG. 2) in additionally recorded area X that has undergone audio after-recording is automatically selected in place of an audio stream (A0 in (d) of FIG. 2) that stores original data. The automatically selected audio stream (A1′) is reproduced and output to an audio output terminal (step S23).

Such operation processing is done when MPU 9 processes according to the program stored in ROM 20. In this way, latest audio data that has undergone the audio after-recording process can be reproduced in synchronism with the related video signal stored together, without any user's notice about the audio after-recording process.

In the optical disc recording/reproduction apparatus according to an embodiment of the present invention, since an audio stream can always be recorded/reproduced together with the related video signal, no buffer occupation by computations for a seek process in mutual access is generated as a result of independent processes of an audio after-recording signal and video signal, and a highly reliable optical disc recording/reproduction system (apparatus) being free of any operation errors can be provided.

As described above, an aspect of the present invention can provide an optical disc recording/reproduction system (apparatus) which can implement an audio after-recording function specified by the DVD video recording application specifications, since it additionally records an audio stream in a new area of even a write-once, read-many optical disc such as DVD-R or the like, which conventionally does not allow an audio after-recording process.

According to the above system (apparatus), the audio after-recording can be repeated using a write-once disc such as DVD-R, CD-R, or the like, such that new audio streams each created by the audio after-recording are additionally recorded on the unrecorded area of the write-once disc, and the corresponding data file (management information) is updated.

Further, the new audio streams additionally recorded on the unrecorded area of the write-once disc can be automatically selected at the time of reproduction.

The audio after-recording using a write-once disc such as DVD-R can be reduced to practice without changing the existing DVD standard.

What is claimed is:

1. A system for recording a primary audio stream and a secondary audio stream on a write-once type recording medium which comprises a data area for recording data including contents of the primary and secondary audio streams and a management area for recording management information for managing the recorded data, said system comprising:
first means for recording a first original audio stream as the primary audio stream on the data area of said recording medium;
second means for recording a second original audio stream as the secondary audio stream on the data area of said recording medium, said second original audio stream being recordable separately from said first original audio stream; and
third means for recording a modified audio stream as the secondary audio stream on the data area of said recording medium, said modified audio stream being obtained by partially or entirely modifying said second original audio stream.

2. The system of claim 1, further comprising:
fourth means for reproducing at least one of the primary and secondary audio streams to provide a reproduced audio stream;
fifth means for partially or entirely replacing the reproduced audio stream with a given audio stream for after recording to provide an after-recording audio stream;
sixth means for recording the after-recording audio stream as the secondary audio stream on the data area of said recording medium.

3. A write-once type recording medium having a data area for recording contents of primary and secondary audio streams and a management area for recording management information of the recorded data, wherein
said data area is configured to record a first original audio stream as the primary audio stream,
said data area is configured to record a second original audio stream as the secondary audio stream, said second original audio stream being recordable separately from said first original audio stream, and
said data area is configured to record a modified audio stream as the secondary audio stream, said modified audio stream being obtained by partially or entirely modifying said second original audio stream.

4. The system of claim 3, wherein said management information includes a first original state indication information indicating that the primary audio stream is an original audio stream.

5. The system of claim 3, wherein said management information includes a first modified state indication information indicating that the primary audio stream has been modified partially or entirely.

6. The system of claim 3, wherein said management information includes a second original state indication information indicating that the secondary audio stream is an original audio stream.

7. The system of claim 3, wherein said management information includes a second modified state indication information indicating that the secondary audio stream has been modified partially or entirely.

8. The system of claim 3, wherein said management information includes a dummy state indication information indicating that the secondary audio stream is a dummy audio stream to be dubbed into an after-recorded audio stream for a future.

9. The system of claim 8, wherein said management information includes an after-recorded state indication information indicating that the secondary audio stream has been modified partially or entirely, in which an after-recorded state indicated by said after-recorded state indication information is able to be transited from only a dummy state indicated by said dummy state indication information.

10. A recording/reproducing apparatus for recording audio visual information including a video signal, first audio stream, and second audio stream on a write-once type optical disc by irradiating the optical disc with a light beam, wherein said disc is provided with first and second areas for recording the audio visual information, said apparatus comprising:
a disc drive configured to rotate the optical disc at a predetermined rotational speed;
a reproduction block configured to read out the video signal, first audio stream and second audio stream stored in the first area of the optical disc, wherein a first set of the video signal and the first audio stream stored in the first area has substantially same contents as a second set of the video signal and the second audio stream stored in the first area, and said second set is selectively reproducible within a same time period as a period for reproducing said first set; and
a recording block configured to prepare a modified audio stream obtained by partially or entirely modifying the second audio stream in accordance with an audio signal for after-recording, to prepare a third set of the video signal and the modified audio stream, and to record contents of the third set in the second area whose location differs from a location of said first area.

11. The apparatus of claim 10, wherein when said third set is recorded on the optical disc, said reproduction block is configured to preferentially select the third set to automatically reproduce the modified second audio stream with the video signal of the third set.
